(19) United States
(12) Patent Application Publication
(10) Pub. No.: US 2004/0037424 A1
(43) Pub. Date: Feb. 26, 2004

(54) Information distribution and processing

(75) Inventors: Masayuki Numao, Kawasaki-shi (JP); Yuji Watanabe, Tokyo-to (JP)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 10/600,547

(22) Filed: Jun. 20, 2003

(30) Foreign Application Priority Data
Jun. 24, 2002 (JP) 2002-183511

(51) Int. Cl. H04L 9/00

(52) U.S. Cl. 380/277

(57) ABSTRACT

Information distribution methods, systems and apparatus are provided in which, rather than specifying the addresses of recipients of a content, a combination of attributes is specified as criteria so that only those recipients that meet the criteria can receive the content. An example embodiment, provides an attribute key management server for managing secret keys and public keys for given attribute values, user terminals for accessing the attribute key management server to obtain attribute secret keys corresponding to their attributes generated based on secret keys, and a provider terminal for generating an encrypted content that can be decrypted by user terminals that has the attribute secret keys corresponding to given attributes. The provider terminal distributes the encrypted content and the user terminals decrypt the encrypted content that can be decrypted by using their attribute secret keys.

### FIELD OF THE INVENTION

The present invention is directed to a database search system. More particularly, it is directed to a system for searching a given database for a given piece of data.

### BACKGROUND ART

In data communication, usually it is necessary to specify the address of recipients of content. The content cannot be sent by specifying attributes of the recipients, like “such and such a person.” In multicasting, on the other hand, a recipient can specify the sender (multicast address) of the content to receive the content. However, whether a recipient is allowed to receive the content cannot be specified by using attributes of the recipient.

Today, there are demands for personalized information (advertisements) and there are many occasions that require exchange of information adapted to personal attributes. Therefore, there is need for a content distribution system in which, rather than directly specifying the addresses of recipients, a combination of attributes is specified as criteria so that only those people who meet the criteria can receive the content. For example, in such a system, criteria such as {gender=male, age=over 30, occupation=office worker, hobby=travel} may be described and recipients, who have registered attributes that meet the criteria can receive the content.

On the other hand, privacy protection is important and personal attributes are the very information that must be protected.

A typical attribute management system for authentication and personalization is Passport from Microsoft Corporation in the U.S.A., (MS Passport). In this system, a single server manages personal information, such as account numbers, about all users. The information is provided to the server, subject to the approval of the users. The information is encrypted before it is transmitted.

A problem with the prior-art attribute management systems such as Passport from Microsoft Corporation described above is that it relies on a server that manages all personal information, entailing complete reliance of the users on the server (and its administrator). This means that in the event that the server attempts to illegally leak personal information about users, the users cannot prevent the leakage.

Even if the server is properly managed, the personal information can be leaked by attack from outside the system because the server provides a single target of attack, namely a single attack point.

### SUMMARY OF THE INVENTION

Therefore, the present invention provides systems, apparatus and methods for an information distribution system in which, instead of directly specifying the addresses of recipients, a combination of attributes is specified as criteria to allow only those who meet the criteria to receive the content while preventing leakage of personal attribute information to third parties, including the sender, throughout the process involved in the submission of the content.

The present invention achieving the object is implemented as an information distribution system characterized by the following configuration. The information distribution system comprises a (1) key management server for managing secret keys and public keys corresponding to given attribute values; (2) a user terminal accessing a key management server to obtain attribute secret keys generated based on secret keys, attribute secret keys corresponding to attributes of its own; (3) and a provider terminal for generating an encrypted content that can be decrypted by a user terminal having a attribute secret keys corresponding to given attributes by means of a public keys; wherein a provider terminal distributes a encrypted content and a user terminal decrypts a encrypted content decryptable by means of the attribute secret keys of its own.

Furthermore, the present invention maybe implemented as a specific information distribution system comprising: a service provider for managing secret keys and public keys for given attribute values; and a plurality of user terminals for accessing the service provider to obtain attribute secret keys corresponding to attributes of their own, the attribute secret keys being generated based on the secret keys; wherein, a given one of the user terminals generates an encrypted content and sends the encrypted content to one or more of the other user terminals, the encrypted content being decryptable by the one or more of the other user terminals having the attribute secret keys corresponding to given attributes by means of the public keys; and the one or more of the other user terminals decrypt the encrypted content decryptable by means of the attribute secret keys of their own.

### BRIEF DESCRIPTION OF THE DRAWINGS

These and other aspects, objects, features, and advantages of the present invention will become apparent upon further consideration of the following detailed description of the invention when read in conjunction with the drawing figures, in which:

FIG. 1 is a diagram showing a general configuration of an information distribution system according to the present invention;

FIG. 2 shows an example of a configuration of an attribute key management server, a provider terminal, and a user terminal according to an embodiment;

FIG. 3 is a diagram showing a protocol for distributing an attribute secret key by using k-out-of-n-OT according to the embodiment;

FIG. 4 is a diagram showing a criteria key generation protocol according to the embodiment;

FIG. 5 shows distribution of a content according to the embodiment;

FIG. 6 shows a schematic diagram of an exemplary hardware configuration of a computer suitable for implementing the attribute key management server, provider terminal, and user terminal according to the embodiment;

FIG. 7 shows a configuration of a personalized-electronic-mail distribution service system to which the information distribution system of the embodiment is applied;

FIG. 8 shows a configuration of a distributed matching service system to which the information distribution system of the embodiment is applied;

FIG. 9 shows an arrangement of distributed search to which the information distribution system of the embodiment is applied; and

FIG. 10 shows an overview of an arrangement of a community key generation method using the information distribution system according to the embodiment.

### DESCRIPTION OF SYMBOLS

10 . . . Attribute key management server

11 . . . Attribute key generator

12 . . . Attribute key storage

20 . . . Provider terminal

21 . . . Encrypted content generator

22 . . . Criteria key generator

30 . . . User terminal

31 . . . Attribute secret key storage

32 . . . Decryptor

### DESCRIPTION OF THE INVENTION

The present invention provides systems, apparatus and methods for an information distribution system in which, instead of directly specifying the addresses of recipients, a combination of attributes is specified as criteria to allow only those who meet the criteria to receive the content while preventing leakage of personal attribute information to third parties, including the sender, throughout the process involved in the submission of the content.

In an example embodiment, the present invention is implemented as an information distribution system characterized by the following configuration. The information distribution system comprises a (1) key management server for managing secret keys and public keys corresponding to given attribute values; (2) a user terminal accessing a key management server to obtain attribute secret keys generated based on secret keys, attribute secret keys corresponding to attributes of its own; and (3) a provider terminal for generating an encrypted content that can be decrypted by a user terminal having a attribute secret keys corresponding to given attributes by means of a public keys, wherein a provider terminal distributes a encrypted content and a user terminal decrypts a encrypted content decryptable by means of the attribute secret keys of its own.

In the example embodiment, the key management server comprises a key storage for storing secret keys and public keys corresponding to predetermined attribute values; an attribute secret key generator for obtaining a set of given attribute values and generating attribute secret keys corresponding to the set of attribute values based on secret keys corresponding to the attribute values among secret keys stored in a key storage; and a sending/receiving unit for receiving the set of attribute values from a given user terminal and sending the attribute secret keys generated by the attribute secret key generator to the user terminal.

The provider terminal comprises a criteria key generator for obtaining public keys corresponding to attribute values indicating attributes of a recipient to which a content is to be sent and using the public keys to generate criteria keys that can be decrypted by secret keys corresponding to the public keys; an encrypted content generator for encrypting the content based on the criteria keys; and a sending unit for sending the encrypted content without specifying any recipient of the content.

The criteria key generator combines based on predetermined rules criteria keys corresponding to the individual attribute values encrypted by using public keys corresponding to the individual attribute values to generate a criteria key for restricting recipients of the content.

The user terminal comprises a sending/receiving unit for accessing a key management server managing secret keys and public keys corresponding to given attribute values to receive attribute secret keys corresponding to attributes established for the information processing apparatus, the attribute secret keys being generated based on the secret keys; and a decryptor for obtaining an encrypted content and decrypting the content based on the attribute secret keys.

The sending/receiving unit sends a set of attribute values indicating attributes established for the information processing apparatus to the key management server and receives the attribute secrete keys generated based on the set of attribute values from the key management server.

The present invention can be implemented as a program for controlling a computer to function as the key management server, provider terminal, and user terminal described above. The program can be stored on a magnetic disc, optical disc, semiconductor memory, or other storage medium and distributed, or can be distributed over a network to provided. Furthermore, the present invention may be implemented as a specific information distribution system as described below.

An information distribution system comprises a service provider for managing secret keys and public keys for given attribute values; and a plurality of user terminals for accessing the service provider to obtain attribute secret keys corresponding to attributes of their own, the attribute secret keys being generated based on the secret keys; wherein, a given one of the user terminals generates an encrypted content and sends the encrypted content to one or more of the other user terminals, the encrypted content being decryptable by the one or more of the other user terminals having the attribute secret keys corresponding to given attributes by means of the public keys; and the one or more of the other user terminals decrypt the encrypted content decryptable by means of the attribute secret keys of their own.

An alternate information distribution system according to the present invention, comprises a key management server for managing secret keys and public keys for given attribute values; and a plurality of user terminals for accessing the key management server to obtain attribute secret keys corresponding to attributes of their own, the attribute secret keys being generated based on the secret keys; wherein a given one of the user terminals generates a group key and sends the group key to ones of the other user terminals and provides a content, the group key being decryptable by the ones of the other user terminals having the attribute secret keys corresponding to given attributes by means of the public keys, the content being only accessible by using the group key.

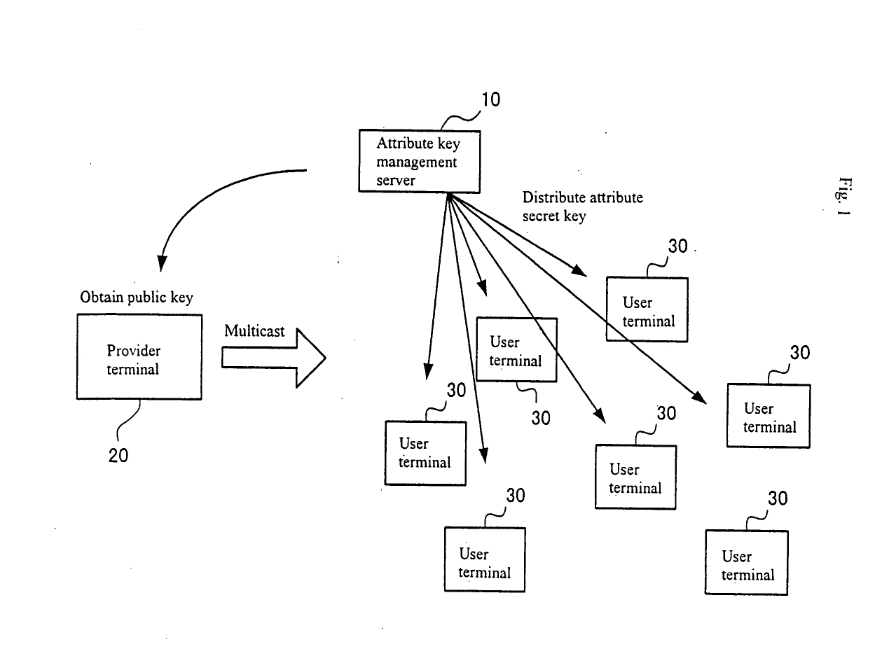

FIG. 1 illustrates a general configuration of an information distribution system according to an example embodiment. Referring to FIG. 1, the information distribution system of the present embodiment comprises an attribute key management server 10 that manages attribute keys used for specifying attributes, a provider terminal 20, which is the sender of contents (information), and user terminal 30, which are recipients of the contents.

The attribute key management server 10, provider terminal 20, and user terminals 30 are implemented by workstations or personal computers, or other computers having network capabilities. The user terminals 30 may be information terminals such as PDAs (personal digital assistants) and cellular phones that have network capabilities. These devices exchange data over a network, which is not shown. The communication links of the network may be wired or wireless.

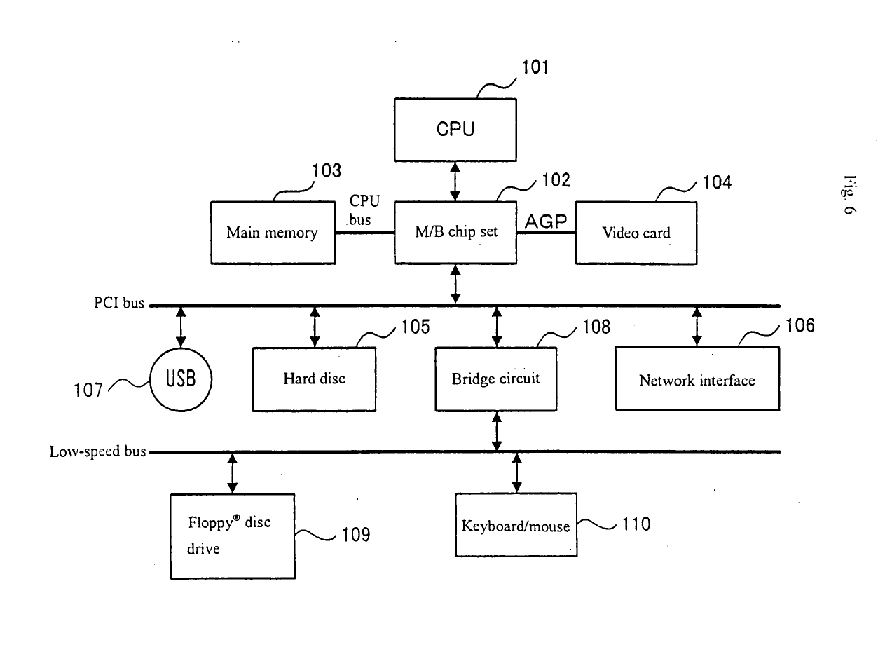

FIG. 6 schematically shows a hardware configuration of a computer suitable for implementing the attribute key management server 10, provider terminal 20, and user terminals 30 according to the present embodiment. The computer shown in FIG. 6 comprises a CPU (Central Processing Unit) 101, which is an arithmetic/logic unit, a main memory 103 connected to the CPU 101 through an M/B (mother board) chip set 102 and a CPU bus, a video card 104 also connected to the CPU 101 through the M/B chip set 102 and an AGP (Accelerated Graphics Port), a hard disc 105 connected to the M/B chip set 102 through a PCI (Peripheral Component Interconnect) bus, and a floppy disc drive 109 and keyboard/mouse 110 which are connected with the M/B chip set 102 through the PCI bus, a bridge circuit 108 and a low-speed bus such as an ISA (Industry Standard Architecture) bus.

The hardware configuration of the computer for implementing the present embodiment shown in FIG. 1 is merely illustrative. Various other configurations to which the present embodiment can be applied may be used. For example, a discrete video memory may be provided instead of the video card 104 and the CPU 101 may process image data. Furthermore, a CD-ROM (Compact Disc Read Only Memory) and DVD-ROM (Digital Versatile Disc Read Only Memory) drives may be attached through an interface such as an ATA (AT Attachment).

The provider terminal 20 in FIG. 1, specifies attributes for identifying the recipients of a content and sends the content to their user terminals 30. Attribute keys provided by the attribute key management server 10 are used for specifying the attributes. Attribute keys are keys (secret key and public key) established for attributes that can be specified in communication from the provider terminal 20 to the user terminals 30. The user terminals 30 may obtain any number of attribute keys for their attributes from the attribute key management server 10. Thus, the provider terminal 20 multicasts a content to the user terminals 30.

The assumption in this embodiment is that attributes and possible values of the attributes (attribute values) are predetermined. The term attribute as used herein refers to information representing the individuality of the user of a user terminal 30 or the user terminal itself. Various types of information can be set as the attributes according to the form and operation of the system used with the present embodiment. Let a set (size=nᵢ) of values that a given attribute Aᵢ can take be Vᵢ={v_{i,1} v_{i,2}, . . . , V_{i,n}}. Because some attributes can take on a plurality of values, the generalization is made that the number of values that an attribute can take is kᵢ (≦nᵢ). These are specific to each attribute. For example, if attribute A₁ is gender, the set of values it can take is V₁={male, female} and therefore n₁=2 and k₁=1.

Attribute criteria are described as follows. That the value of a given attribute Aᵢ is vᵢ is written Aᵢ (vᵢ). Furthermore, AND and OR operators, &, |, and parentheses ( ) are used. For example, attributes {gender=male, age=30's, occupation=office worker, hobby=travel or PC operation} are written as follows:

gender (male) & age (30's) & occupation (office worker) & (hobby (travel)|hobby (PC operation)).

Furthermore, in the following description, p is a large prime, q is a prime that can divide p−1, and g is an element of the order q in a finite field Z_{p.} All the arithmetic operations are performed in Zₚ unless otherwise stated.

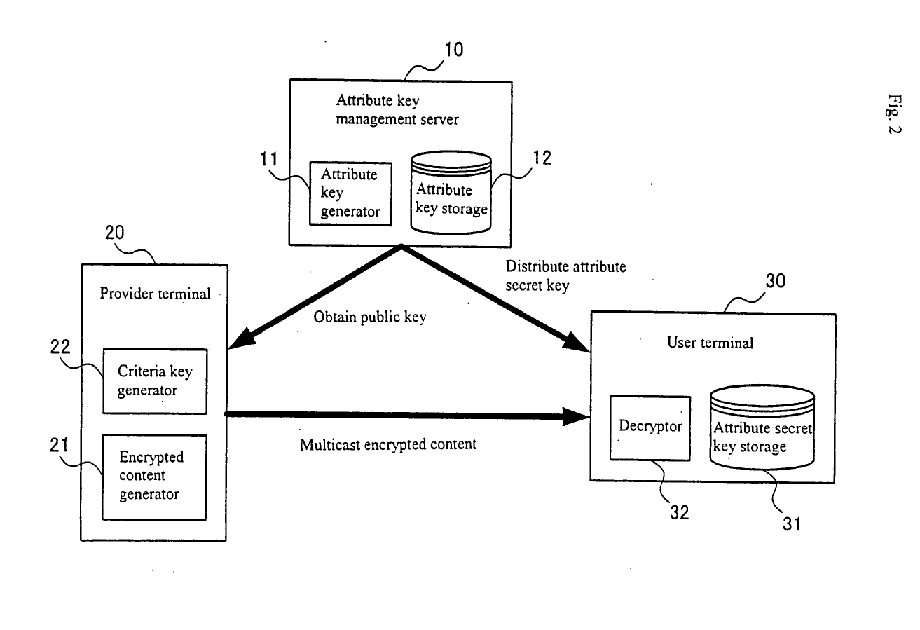

FIG. 2 shows a configuration of the attribute key management server 10, the provider terminal 20, and a user terminal 30 according to the present embodiment. Referring to FIG. 2, the attribute key management server 10 comprises an attribute key generator 11 for generating attribute keys and an attribute key storage 12 for storing the generated attribute keys. The attribute key generator 11 generates a secret key and a public key for each of attribute predetermined as attribute keys and generates secret keys (attribute secret keys) corresponding to individual attributes of individual user terminals 30 by communicating with them. The generated attribute secret keys unique to the user terminals 30 are sent to those user terminals 30.

The attribute key generator 11 is a virtual software block implemented by the CPU 101 under the control of a program in the computer constituting the attribute key management server 10. The attribute key storage 12 is implemented by a storage device (magnetic disc device, optical disc device, semiconductor memory, or the like) of the computer constituting the attribute key management server 10. The attribute key management server 10 also includes a sending/receiving unit, which is not shown, implemented by the program-controlled CPU 101 and network a network interface 106.

The provider terminal 20 comprises an encrypted content generator 21 for encrypting contents to be distributed and a criteria key generator 22 for generating criteria keys used for decrypting encrypted contents. The encrypted content generator 21 encrypts a content itself with a common key known as a session key. The criteria key generator 22 generates a key including information for encrypting and decrypting a session key as the criteria key, rather than generating a key for directly decrypting the content.

The encrypted content generator 21 and the criteria key generator 22 are virtual software blocks implemented by a program-controlled CPU 101 in the computer constituting the provider terminal 20. The provider terminal 20 includes a sending/receiving unit implemented by the program-controlled CPU 101 and a network interface 106.

The user terminal 30 comprises an attribute secret key storage 31 for holding an attribute secret key unique to the user terminal 30 that is obtained from the attribute key management server 10 and a decryptor 32 for decrypting encrypted contents distributed from the provider terminal 20 with the attribute secret key stored in the attribute secret key storage 31.

The attribute secret key storage 31 is implemented by a storage device (magnetic disc device, optical disc device, semiconductor memory or the like) of the computer or information terminal constituting the user terminal 30. The decryptor 32 is a virtual software block implemented by a program-controlled CPU 101. The user terminal 30 includes a sending/receiving unit, which is not shown, implemented by the program-controlled CPU 101 and a network interface 106. An example of a protocol used for implementing the information distribution system according to the embodimentincludes the following three phases:

1. Generation and distribution of attribute keys as preprocessing,

2. Generation of criteria keys by the provider terminal 20, and

3. Distribution of contents through multicasting.

Each of these phases will be described in detail below.

1. Generation and Distribution of Attribute Keys

The attribute key generator 11 of the attribute key management server 10 selects an attribute secret key s_{i,j} at random for each value in a set of attribute values {v_{i,1}, v_{i,2}, . . . , V_{i,n}} for registered attributes Aᵢ and publishes an attribute public key

y_{i,j}=g^{s}^{_{i,j}}(mod p) [Equation 1]

The user terminal 30 communicate with the attribute key management server 10 and performs Oblivious Transfer (herein after abbreviated to OT) to secretly obtain attribute secret keys for attribute values of itself without being known to the attribute key management server 10. OT is a protocol between two parties, an information provider and an information selector, in which the selector selects and obtains some pieces of information held by the provider. Here, the following two conditions must be met:

(1) Privacy of the selector: the provider is not allowed to know which information is selected by the selector, and

(2) Privacy of the provider: the selector is not allowed to know other information than the selector selected.

OT is disclosed in the following literature:

M. Bellare and S. Micali, Non-interactive oblivious transfer and applications, Advances in Cryptology—Crypto '89, pp. 547-557, 1990.

One basic OT is 1-out-of-2-OT. In this OT, a provider has two pieces of information and a selector selects one of them. A typical protocol to achieve this is one that uses ElGamal encryption. This protocol will be described below. Here, let the pieces of information held by the provider be I₀, I₁ and the value selected by the selector be b∈{0,1},˜b=NOT b.

(1) The information provider generates a random number r and sends it to the selector,

(2) The selector uses the random number r it received to generate K_{b}=g^{x}, K_{-b}=r/K_{b} and sends it to the information provider,

(3) The information provider checks to see if K₀*K₁=r

(4) The information provider generates an encrypted content {E_{I1}, E_{I2}} and sends it to the selector, where E_{I1}=(g^{h}, I₀*K₀^{h}) and E_{I2}=(g^{h}, I₁*K₁^{h}), and

(5) The selector decrypts the content I_{b}.

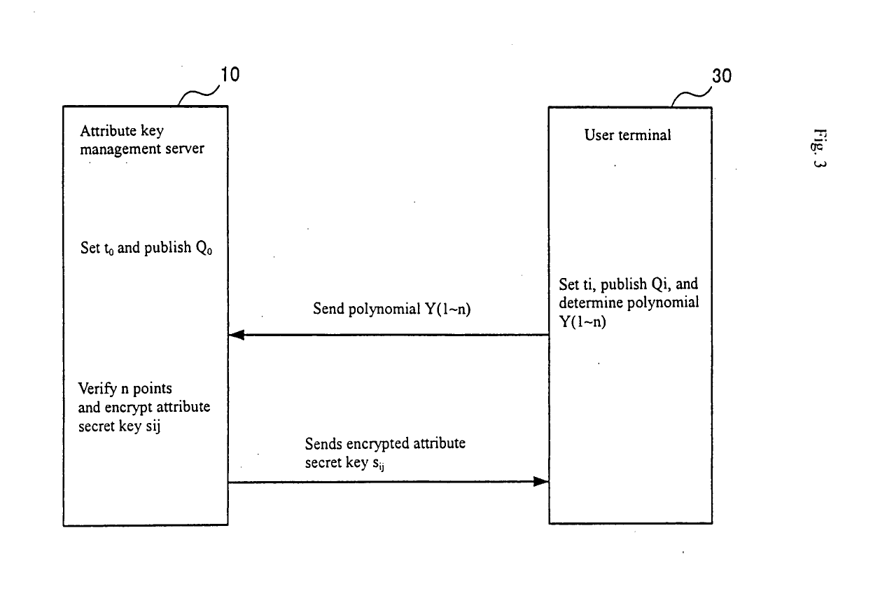

1-out-of-2-OT protocol has been described above in which one of two pieces of information is selected. In the present embodiment, this protocol is expanded to k-out-of-n-OT, in which k pieces of information are selected out of n pieces of information, where k may be any number. This protocol will be detailed with reference to FIG. 3.

Assume that the number of attributes Aᵢ is n and k values can be selected.

(1) The attribute key management server 10 in advance determines a secret value t₀ and in advance publishes

Q₀=g^{t}^{₀}(modp) [Equation 2]

(2) The user terminal 30 determines k secret keys {t₁, t₂, . . . , tₖ} at random and calculates their public keys

Qᵢ=g^{t}^{ᵢ}(mod p) [Equation 3]

Suppose that a set of k attribute values {v_{i,h(1)}, v_{i,h(2)}, . . . , v_{i,h(k)}} selected from a set of n attribute values {v_{i,1}, v_{i,2}, . . . , v_{i,n}} is attributes of the user terminal 30. A polynomial of order k Y(x) passing through k+1 points {(0, Q0), (h(1), Q1), . . . , (h(k), Qk)} can be uniquely determined by using Lagrangian interpolation. This polynomial is used to send n points {Y(1), Y(2), . . . , Y(n)} to the attribute key management server 10 (there is no need to use a secret communication link).

(3) The attribute key generator 11 of the attribute key management server 10 verifies that the n points published by (sent from) the user terminal 30 are on the k-order polynomial by using a method, which will be described below. If they are exactly the points on the k-order polynomial, the attribute key generator 11 sends the attribute secret keys Sᵢⱼ, each of which is encrypted by Y(j) as an Elgamal encryption public key, to the user terminal 30 (there is no need to use a secret communication link).

For verification that the n points are on the k-order polynomial K points are randomly selected from a set of n points {Y(1), . . . Y(n)} to form F(x): a polynomial of order k, then check that F(o)=Qo.

(4) The user terminal 30 can decrypt only the k points specified by h(j) (1≦j≦k) from (out of) n ElGamal-encrypted points, by using the attribute secret key sᵢⱼ received from the attribute key management server 10. Thus, it can obtain k attribute secret keys.

Beside k-out-of-n-OT described above, attribute secret keys for numerical attributes are generated by using the following representation:

(1) Let the binary expression of an n-bit positive integer x be (xₙ₋ᵢ, . . . , x₀).

(2) The attribute key generator 11 of the attribute key management server 10 generates 2n pairs of a secret key and a public key {(pkⱼ⁽⁰⁾, skⱼ⁽⁰⁾), (pkⱼ⁽¹⁾, skⱼ⁽¹⁾)(j=0, . . . , n−1) and assigns the two types of secret keys to each bit. That is, it assigns skⱼ⁽⁰⁾ and skⱼ⁽¹⁾ to j-th bit. It publishes public keys pkj(0) and pkj(1) corresponding to them.

(3) A user terminal 30 that selects the value X=(xₙ₋₁, . . . , x₀) through the attribute key distribution using n times 1-out-of-2 OT, which is described earlier, obtains (skⱼ^{(xn-1)}, . . . , skⱼ^{(x0)}).

As described above, k-out-of-n-OT and, 1-out-of-2 OT for numerical attributes, are used to distribute attribute secret keys, which allow the user terminal 30 to obtain attribute secret keys corresponding to attributes of itself without allowing even the attribute key management server 10 to know them, that is, without leaking its personal information.

2. Criteria Key Generation

The criteria key generator 22 of the provider terminal 20 combines attribute public keys published by the attribute key management server 10 as below to generate a criteria key. E(PK, K) represents that session key K is encrypted with public key PK. Eₖ(M) represents that message M is encrypted with symmetric key K.

(1) Construction of AND key: Attribute public keys yᵢⱼ and yₖ₁ correspond to attribute criteria Aᵢ(vᵢⱼ) & Ak(vₖ₁), respectively. Two session keys Kᵢⱼ and Kₖ₁ are selected at random and encrypted with a public key, resulting in a criteria key {E(yᵢⱼ, kᵢⱼ), E(yₖ₁, Kₖ₁)} and its corresponding session key K=Kᵢⱼ+Kₖ₁. In addition, E(yᵢⱼ, E(yₖ₁, K)) is an encryption constituting AND.

(2) Construction of OR key: Attribute public keys yᵢⱼ and yₖ₁ correspond to attribute criteria Aᵢ(vᵢⱼ)|Ak(vₖ₁), respectively. One of the session keys K is selected at random and-encrypted with the two public keys. The resulting criteria key is {E(yᵢⱼ, K), E(yₖ₁, K)}.

(3) Construction of NOT key: Attribute public keys yᵢₖ, k=1, . . . , j−1, j+1, . . . , nᵢ correspond to attribute criteria Aᵢ(vᵢⱼ). One session key K is selected at random and encrypted with nᵢ−1 keys. The resulting criteria key is E (yᵢₗ, K)|| . . . ||E (yᵢⱼ₋₁, K)||E(yᵢⱼ₊₁, K)|| . . . ||E(yᵢₙᵢ, K).

(4) Combined AND/OR criteria: Criteria keys and session keys for any combinations of AND and OR can be generated by repeating the process described above, starting from the lowest-level operator, to concatenate criteria keys and calculating session keys.

Furthermore, consider a case where the provider terminal 20 wants to allow a content to be decrypted if X≧Y holds for a given n-bit positive integer Y=(yₙ₋₁, . . . , y₀). The criteria key generator 22 of the provider terminal 20 calculates C=(cₙ₋₁, . . . , c₀) as follows. Here, kₙ₋₁, . . . , k₀ are random number and k₀=K is a session key for numerical attribute criteria (X≧Y). cₙ₋₁, . . . , c₀ are determined as follows:

cⱼ=E(sk⁽¹⁾ⱼ, kⱼ) if yⱼ−1

cⱼ=E(sk⁽⁰⁾ⱼ, K)||E(sk⁽¹⁾ⱼ, kⱼ) if yⱼ=0.

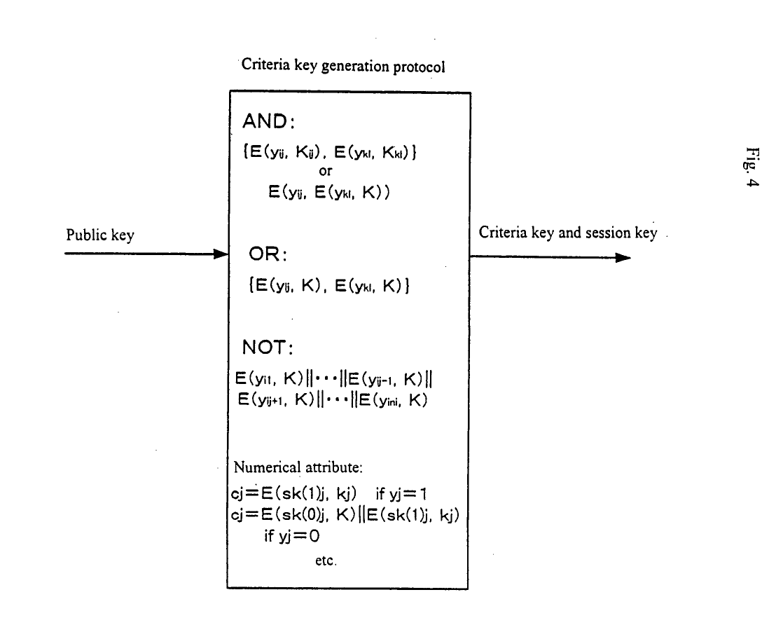

The provider terminal 20 sends a criteria key (cₙ₋₁, Eₖₙ₋₁(cₙ₋₂), . . . , Eₖ₁(c₀)) to the user terminal 30. The user terminal 30 can determine k if X≧Y. Likewise, criteria keys for X>Y, X≦Y, and X<Y can be generated. Numerical attribute criteria generated using this method can be combined to generate a criteria key such that Y≦X≦Y′. FIG. 4 shows a diagram for illustrating the protocol described above.

3. Distribution Through Multicasting

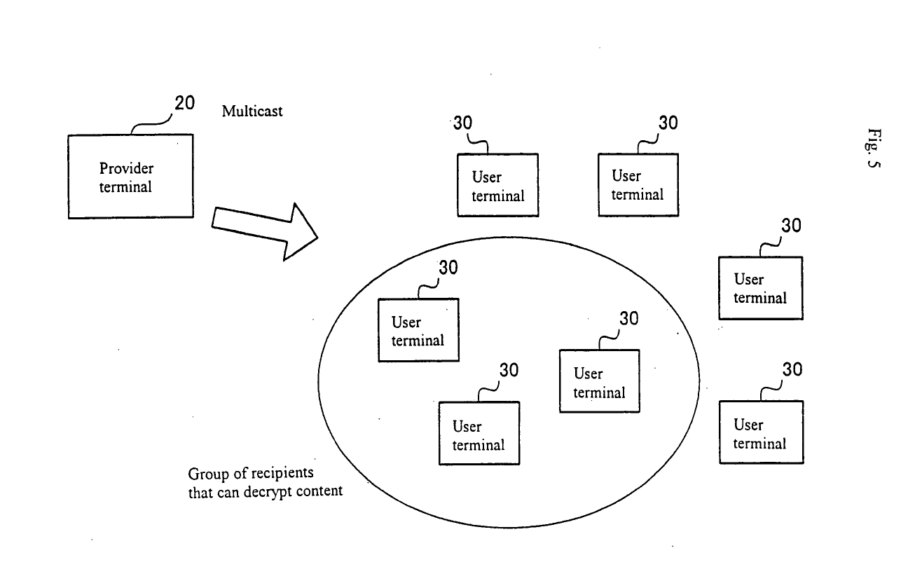

The provider terminal 20 adds a criteria key generated by using the criteria key generation protocol described above to the header of a content, encrypts the body of the content with a session key generated by using the criteria key generation protocol, and multicasts the encrypted contents with the content header. FIG. 5 shows a diagram for explaining the multicasting. Only user terminal 30 having an attribute secret key that meets the conditions of the criteria key can decrypt the multicasted content.

The information distribution system according to the present embodiment arranged as described above has the following main characteristics.

(1) Efficiency and Off-Line Characteristics of Key Acquisition

The user terminal 30 can receive attribute secret keys from the attribute key management server 10 with the one-round protocol. Furthermore, once the user terminal 30 obtains the keys, it can use the keys in any number of subsequent multicasts.

(2) Provider Terminal Registration not Required

The provider terminal 20 can use attribute public keys of the attribute key management server 10 without having to interacting with the attribute key management server 10. The attribute public keys can be reused.

(3) Off-Line Nature of Attribute Key Management Server 10

The attribute key management server 10 involves only in key acquisition by the user terminal 30. It was not involved in actual communication. Therefore, any protocols for a standard multicast such as IP multicast or broad cast can be used in the actual communication.

(4) Openness of Recipient Group

The provider terminal 20 can send a content through a multicast without knowing the entire recipient group or a whole set that can receive the content. Conversely, the user terminal 30 can join the recipient group by receiving attribute secret keys from the attribute key management server 10 at any time.

A specific example of the information distribution system to which the present embodiment can be applied will be described below.

1. Personalized Electronic Mail Distribution Service

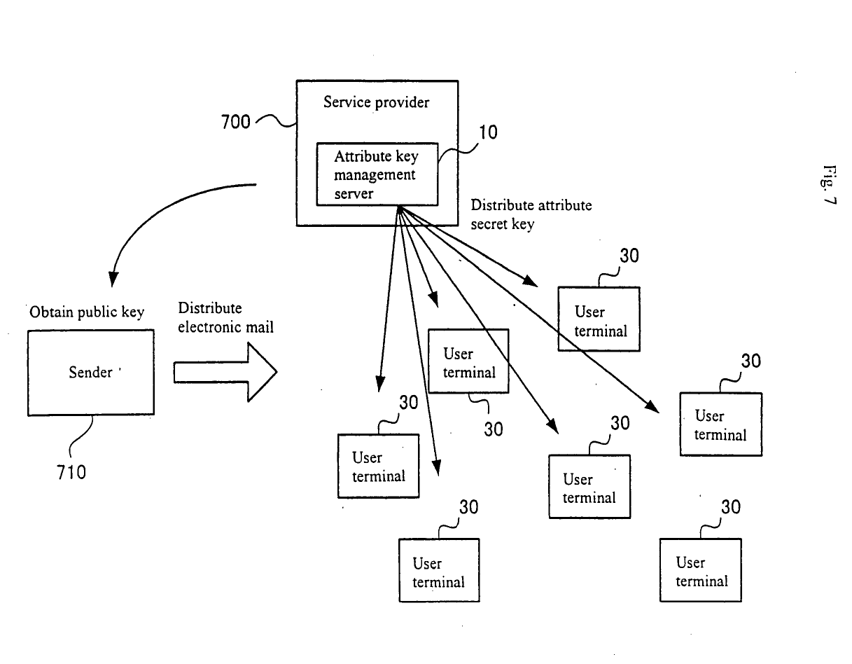

There are systems distributing electronic mail to a plurality of or unspecified users through a service provider. In such a system, the service provider 700 can operate an attribute key management server 10 and an electronic mail sender 710 can act as a provider terminal 20 to distribute electronic mail messages encrypted based on a criteria key corresponding to given attributes. FIG. 7 shows a general configuration of this system.

According to the present embodiment, the sender of electronic mail specifies attributes of recipients of the mail but cannot know who has the specified attribute. Therefore, the privacy concerning attributes of the users can be fully protected. Thus, the users can obtain secret keys for attributes of themselves and receive personalized information. Unlike models in conventional database marketing used by a sender to select recipients by inference, this system allows the recipients to actively obtain information that they want, therefore distribution with a higher hit rate can be expected.

2. Distributed Matching Service System

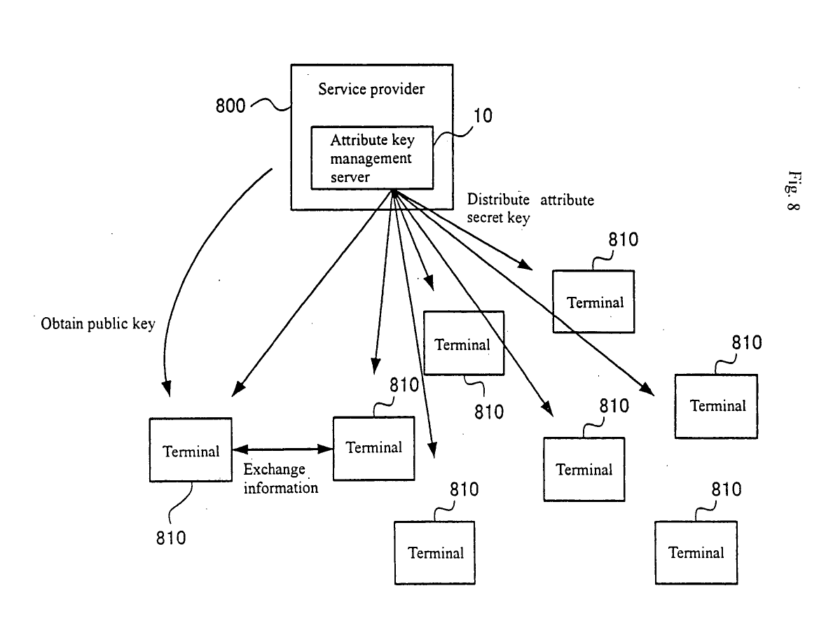

There are services for a plurality of or unspecified users to exchange queries and information with each other. One example is matching service on a network. In matching service, members, or users, exchange conditions and information about their profile to find a marriage partner based on the information. A service provider 800 manages an attribute key management server 10 and each user terminal 810 acts as a provider terminal 20 as well as a user terminal 30. A user specifies as attributes conditions and items of profile information to exchange and exchanges messages encrypted based on a criteria key corresponding to the attributes. Therefore, they can exchange the information with each other with information other than the exchanged information being completely hidden. FIG. 8 shows a general configuration of the system.

3. Distributed Search Service System

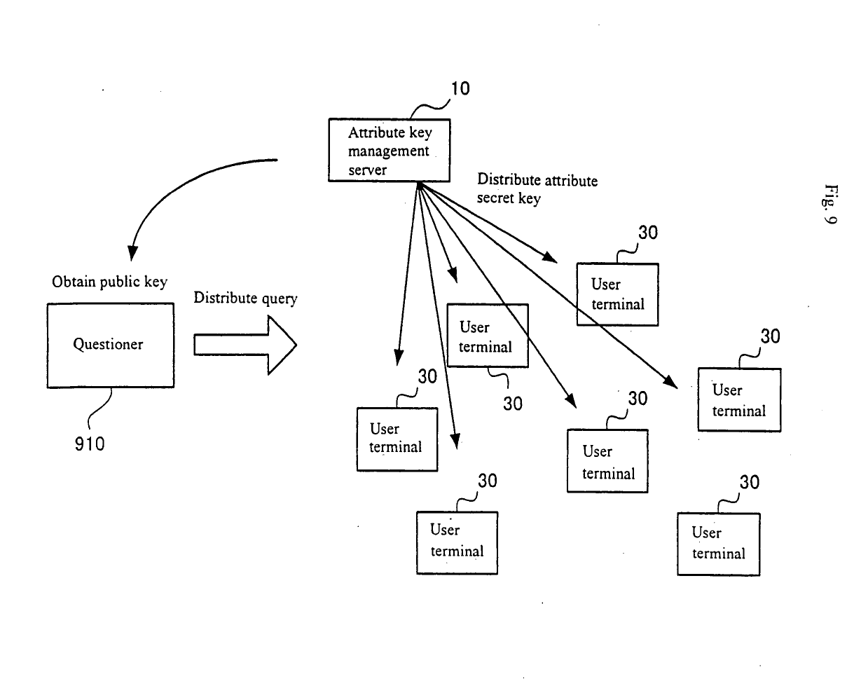

The operator of a search engine site operates an attribute key management server 10 and registers attributes such as specialties as keywords. A user terminal 30 obtains its attribute secret key for its specialty. A questioner 910 equivalent to a provider terminal 20 combines keywords to construct a question and transmit it over a network. A given user terminal 30 can decrypt and read the question and reply to it only if it matches its specialty. FIG. 9 shows a general configuration of this system.

4. Community Key Generation Method

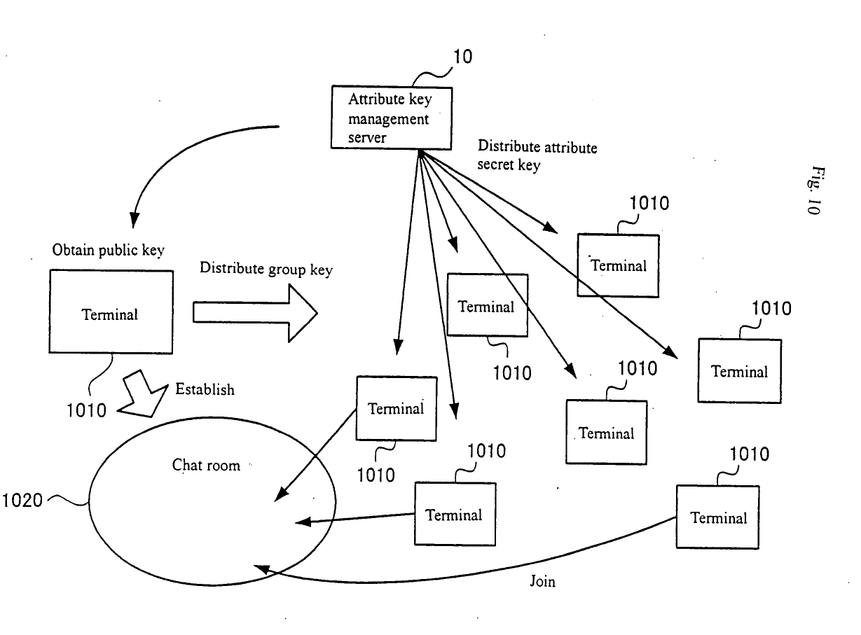

FIG. 10 shows a general configuration of a community key generation method using an information distribution system according to the present embodiment. A network operator such as an ISP (Internet Service Provider) operates an attribute key management server 10. It registers attributes such as topics on a community. The members of the community use a terminal 1010 acting as a provider terminal 20 as well as a user terminal 30. They obtain attribute secret keys for topics of interest to them with a function as the user terminal 30. A given member combines sets of attribute criteria at will, hosts a chat room 1020, generates its group key as a message, encrypts it based on a criteria key corresponding to the attribute criteria, and distribute it to the other members. Thus, only the recipients that meet the attribute criteria can decrypt the group key and join the chat room 1020. Of course, criteria keys and attribute secret keys for obtaining various contents on the network can also be established.

Thus, according to the present invention, an information distribution system is provided in which, instead of directly specifying the addresses of recipients, a combination of attributes is specified as criteria to allow only those who meet the criteria to receive the content while preventing leakage of personal attribute information to third parties, including the sender, throughout the process involved in the submission of the content.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. An information distribution system comprising:
a key management server for managing secret keys and public keys corresponding to given attribute values;
a user terminal for accessing said key management server to obtain attribute secret keys generated based on said secret keys, said attribute secret keys corresponding to attributes of said user terminal; and
a provider terminal for generating an encrypted content that can be decrypted by said user terminal having said attribute secret keys corresponding to given attributes by means of said public keys,
wherein said provider terminal distributes said encrypted content and said user terminal decrypts said encrypted content decryptable by means of said attribute secret keys of its own.

2. The information distribution system according to claim 1, wherein said provider terminal distributes said encrypted content without specifying said user terminal that is to receive said encrypted content.

3. The information distribution system according to claim 1, wherein said user terminal sends a set of attribute values indicating attributes of its own to said key management server; and
said key management server generates said attribute secret keys unique to said user terminal based on, among said secret keys managed by said key management server, secret keys corresponding to the attribute values sent from said user terminal and sends said attribute secret keys to said user terminal.

4. A server comprising:
a key storage for storing secret keys and public keys corresponding to predetermined attribute values;
an attribute secret key generator for obtaining a set of given attribute values and generating attribute secret keys corresponding to said set of attribute values based on secret keys corresponding to said attribute values among said secret keys stored in said key storage; and
a sending/receiving unit for receiving said set of attribute values from a given user terminal and sending said attribute secret keys generated by said attribute secret key generator to said user terminal.

5. The server according to claim 4, wherein said attribute secret key generator generates said attribute secret keys by using a protocol implementing oblivious transfer.

6. An information processing apparatus comprising:
a criteria key generator for obtaining public keys corresponding to attribute values indicating attributes of a recipient to which a content is to be sent and using said public keys to generate criteria keys that can be decrypted by secret keys corresponding to said public keys;
an encrypted content generator for encrypting said content based on said criteria keys; and
a sending unit for sending said encrypted content without specifying any recipient of said content via a network.

7. The information processing apparatus according to claim 6, wherein said criteria key generator combines, based on predetermined rules, criteria keys corresponding to the individual attribute values encrypted by using public keys corresponding to said individual attribute values to generate a criteria key for restricting recipients of said content.

8. The information processing apparatus according to claim 6, wherein said criteria key generator generates a session key for encrypting said content and a criteria key for decrypting said session key; and
said encrypted content generator uses said session key to encrypt said content.

9. An information processing apparatus receiving a content distributed over a network, comprising:
a sending/receiving unit for accessing a key management server managing secret keys and public keys corresponding to given attribute values to receive attribute secret keys corresponding to attributes established for said information processing apparatus, said attribute secret keys being generated based on said secret keys; and
a decryptor for obtaining an encrypted content and decrypting said content based on said attribute secret keys.

10. The information processing apparatus according to claim 9, wherein said sending/receiving unit sends a set of attribute values established for said information processing apparatus to said key management server and receives said attribute secrete keys generated based on said set of attribute values from said key management server.

11. A program for controlling a computer to generate a decryption key for decrypting information encrypted with a given public key, said program causing said computer to implement the functions of claim 4.

12. The program according to claim 11, wherein said computer-implemented function of generating said attribute secret key generates said attribute secret keys by using a protocol implementing oblivious transfer.

13. A program for controlling a computer to encrypt and distribute a given content, causing said computer to implement the functions of claim 6.

14. The program according to claim 13, wherein said computer-implemented function of generating said criteria key combines, based on predetermined rules, criteria keys corresponding to the individual attribute values encrypted by using public keys corresponding to said individual attribute values to generate a criteria key for restricting recipients of said content.

15. A program for controlling a computer to receive content distributed over a network, causing said computer to implement the functions of:
accessing a key management server managing secret keys and public keys corresponding to given attribute values to receive attribute secret keys corresponding to attributes established for said information processing apparatus according to claim 6, said attribute secret keys being generated based on said secret keys; and
obtaining the encrypted content and decrypting said encrypted content based on the attribute secret keys.

16. A storage medium containing a program in computer readable form for controlling a computer to generate decryption key for decrypting information encrypted with a given public key, said program causing said computer to implement the functions of claim 4.

17. A storage medium containing a program in computer readable form for controlling a computer to encrypt and distribute a given content, said program causing said computer to implement the functions of claim 6.

18. A storage medium containing a program in computer readable form for controlling a computer to receive a content distributed over a network, said program causing said computer to implement the functions of claim 9.

19. A key distribution method for controlling a computer to generate and distribute a decryption key for decrypting information encrypted with a given public key, comprising the steps of:
generating n secret keys and n public keys corresponding to said secret keys and storing said secret keys and public keys in a given storage;
obtaining information about k (≦n) secret keys selected at random by a given client from among said n secret keys stored in said storage;
reading said k secret keys corresponding to information about the obtained secret keys from said storage and using a protocol for implementing oblivious transfer to generate decryption keys for decrypting information encrypted with said k public keys corresponding to the k secret keys; and
providing said generated decryption keys to said client.

20. An information distribution system comprising:
a service provider managing secret keys and public keys for given attribute values; and
a plurality of user terminals for accessing said service provider to obtain attribute secret keys corresponding to attributes of their own, said attribute secret keys being generated based on said secret keys;
wherein, a given one of said user terminals generates an encrypted content and sends said encrypted content to one or more of the other user terminals, said encrypted content being decryptable by said one or more of the other user terminals having said attribute secret keys corresponding to given attributes by means of said public keys; and
said one or more of the other user terminals decrypt said encrypted content decryptable by means of said attribute secret keys of their own.

21. An information distribution system comprising:
a key management server for managing secret keys and public keys for given attribute values; and
a plurality of user terminals for accessing said key management server to obtain attribute secret keys corresponding to attributes of their own, said attribute secret keys being generated based on said secret keys,
wherein a given one of said user terminals generates a group key and sends said group key to ones of the other user terminals and provides a content, said encrypted group key being decryptable by said ones of the other user terminals having said attribute secret keys corresponding to given attributes by means of said public keys, said content being only accessible by using said group key.

22. An article of manufacture comprising a computer usable medium having computer readable program code means embodied therein for causing key distribution, the computer readable program code means in said article of manufacture comprising computer readable program code means for causing a computer to effect the steps of claim 19.

23. A program storage device readable by machine, tangibly embodying a program of instructions executable by the machine to perform method steps for key distribution, said method steps comprising the steps of claim 19.

24. A computer program product comprising a computer usable medium having computer readable program code means embodied therein for causing key distribution, the computer readable program code means in said computer program product comprising computer readable program code means for causing a computer to effect the functions of claim 20.

25. A computer program product comprising a computer usable medium having computer readable program code means embodied therein for causing key distribution, the computer readable program code means in said computer program product comprising computer readable program code means for causing a computer to effect the functions of claim 21.
